(19) United States
(12) Patent Application Publication
(10) Pub. No.: US 2015/0345805 A1
(43) Pub. Date: Dec. 3, 2015

(54) Heat Energy Storage System and Method For Hot Water Systems

(71) Applicant: Andrew BUTLER, Sunnyvale, CA (US)

(72) Inventor: Andrew Butler, Palo Alto, CA (US)

(73) Assignee: D2M INTERNATIONAL, Kowloon OT (HK)

(21) Appl. No.: 14/760,983

(22) PCT Filed: Jan. 15, 2014
(86) PCT No.: PCT/US14/11734

§ 371 Date: Jul. 14, 2015

Related U.S. Application Data
(60) Provisional application No. 61/752,918, filed on Jan. 15, 2013.

(51) Int. Cl. F24D 19/10; G05B 15/02

(52) U.S. Cl. CPC F24D 19/1063; G05B 15/02; F24D 2220/04; F24D 2220/209

(57) ABSTRACT

A programmable, user-controllable heat storage system and method to provide instant hot water on demand at the desired time while avoiding the waste of energy resulting from continuous pre-heating.

### CROSS-REFERENCE TO RELATED APPLICATIONS

The present application claims the benefit of PCT Application No. PCT/US/14/11734, filed Jan. 15, 2014, which claims the benefit of U.S. Provisional Patent Application No. 61/752,918, filed Jan. 15, 2013, which is incorporated herein by reference in its entirety.

### FIELD OF THE INVENTION

The present invention relates generally to heat storage devices for water, and specifically to a user-controllable programmable system and method for providing instant hot water when needed.

### BACKGROUND

Everyone is familiar with the problem of turning on the hot water tap and having cold water come out for the first few minutes. In most water systems, the hot water pipes that lead from the heater to the point of use (shower or tap) are filled with water when the tap or shower is not running. That water cools off during the time when the tap or shower is not in use; therefore, when the tap or shower is first turned on after a period of disuse, that cool water is the first water that comes out. Since most people are not interested in taking a cold shower when they need a hot shower, or in using cold water when they need hot water, that water is typically wasted.

Various prior art systems address this issue. For example, a system typically used in hotels and similar accommodations comprises a hot water circulation facility, which continuously circulates hot water from a hot water source to the tap and then back to the hot water source. This prevents the water from cooling off and allows hot water to come out immediately when the hot water tap is turned on. However, such a system is not energy efficient, since the hot water is continuously circulated whether or not it is needed.

Some other systems use a separate heater and water tank at the point of use, so that a small tank of hot water is always available at the tap or shower. While such systems deliver hot water immediately at the point of use, making them convenient for the household user, they heat the water continuously, which is not energy efficient, since many users are not home during the day, do not use hot water at night while they are sleeping, and typically only require instant hot water at one or two occasions during the day.

Most household users have a fairly clear idea of when they need to use hot water. For example, someone who works a 9-to-5 job is not home during the day; heating the water during that time is wasteful and unnecessary. Also, most people take a shower at the same time each day; thus, hot water in large quantities may only be needed at a particular time each day, and not needed at any other time.

A need therefore exists for a system and method of providing pre-heated water to the hot water tap only when actually needed by the user.

### SUMMARY OF THE INVENTION

An object of the present invention is to provide a hot water system that uses less energy than prior art hot water systems and prevents wasted water and energy.

Another object of the present invention is to provide a hot water system that provides instant hot water on demand.

Another object of the present invention is to provide a hot water system that adapts to the user's actual usage patterns.

Another object of the present invention is to provide a hot water system that only heats the water when the user is likely to require hot water.

Another object of the present invention is to provide a hot water system that can be controlled by a smartphone or other mobile device.

In one of its embodiments, the present invention is a hot water system that comprises a heat storage device, a heater, a controller that controls the heater, the heat storage device, or both, and a communications interface that enables the controller to communicate wirelessly with a smartphone, tablet, or other mobile device. The heat storage device may be a heat capacitor, a hot water tank, or any other heat storage or hot water storage device known in the art. In the preferred embodiment, the heat storage device is capable of storing or heating enough hot water so as to meet a typical anticipated need. The heater may be any type of water heater known in the art, as long as it can be controlled by the controller.

In one embodiment, the present invention also comprises a time and temperature monitor that analyzes water usage data. Such a time and temperature monitor may measure water flow rate, water pressure, timing of water use, quantity of water used, water temperature, and any other parameters relevant to a hot water system. The water usage data is then preferably used to predict future hot water use, and to deactivate the heater when hot water is unlikely to be required, while activating it when hot water is likely to be required.

In another embodiment, the present invention enables a user to input a hot water usage pattern into the controller, preferably (but not necessarily) inputting times when hot water is likely to be required, times when hot water is not likely to be required, approximate amounts of hot water required, and any other parameters relevant to hot water use. This hot water usage pattern is then preferably used to activate the hot water heater when needed and to prepare a sufficient quantity of hot water so that the hot water flows instantly when the tap is turned on. The hot water usage pattern is preferably also used to deactivate the hot water heater when not needed—for example, when the user is at work during the day.

In another embodiment, the present invention comprises a sensor that detects activity that is likely to correlate to a need for hot water, which triggers the hot water heater to turn on. The sensor may be a motion detector (to detect motion in the kitchen/bathroom), a light sensor, a sensor connected to a door to detect when it is opened, a GPS sensor on the user's smartphone that triggers the smartphone to turn on the hot water heater when the user approaches the house, and so on. The sensor may also detect activity that is likely to correlate to a lack of need for hot water and trigger the hot water heater to turn off. For example, the hot water heater may turn off when the GPS sensor on the user's smartphone shows that the user is further than a predetermined distance from the house; or a sensor connected to the user's bed may be triggered when the user is in bed (and therefore unlikely to require hot water).

The present invention may comprise any combination of manual control, learned behavior, and sensors, or all of the above.

### LIST OF FIGURES

FIG. 1 shows a diagram of one embodiment of the system of the present invention.

FIG. 2 shows a flowchart of one embodiment of the system of the present invention.

### DETAILED DESCRIPTION OF THE INVENTION

The present invention is a heat storage system and method for hot water systems that is programmable or controllable by the user to only heat the water when actually needed. In one embodiment, the user can control the heat storage system by their smartphone 120, via wi-fi, Bluetooth, or a cellular connection 130. In another embodiment, the heat storage system learns the user's water usage patterns and automatically heats the water only when the user is likely to need it and only to the temperature the user is likely to want. In another embodiment, the user can pre-program the system to heat the water to the desired temperature when needed. The system can also comprise a sensor to detect the presence of people in the house, and only heat the water when people are present in the house, in the same room as the tap or shower, or in the near vicinity of the tap or shower. In the preferred embodiment, the heat storage system is installed at the point of use—i.e. immediately upstream from the water tap or shower. Several such systems may therefore be used—one in the kitchen, one in the shower, and so on. Alternately, one system may be used for the entire house or apartment.

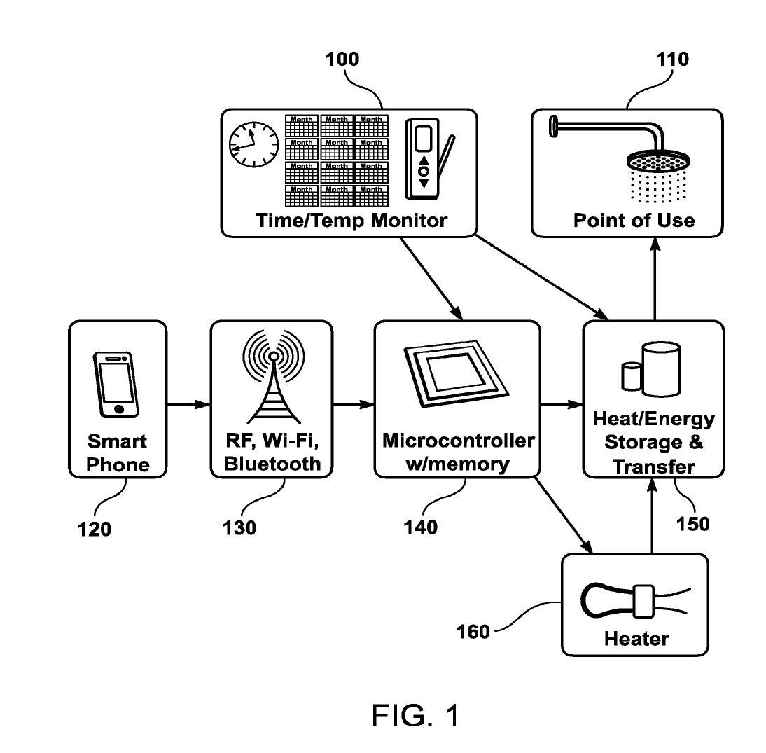

As shown in FIG. 1, the preferred embodiment of the present invention is a programmable water heat storage system and method controllable by a smartphone 120. A user can input the desired hot water heating patterns into the system by using a smartphone 120—preferably with a special app installed. Other input devices may also be used, such as a conventional cell phone, a tablet, an Internet-connected computer, or a dedicated remote control. The data is then transmitted to the microcontroller 140 via RF, wi-fi, Bluetooth, or any other data transmission methods known in the art 130. The microcontroller 140 then transmits commands to the heater 160 and to the heat/energy storage and transfer device 150, activating them at the desired time and letting them run until the water reaches the desired temperature. The heated water is then provided to the point of use 110 (i.e. the tap or shower).

Alternately, as also shown in FIG. 1, a time and temperature monitor 100 continuously analyzes the user's water usage patterns—the amount of water demanded, the temperature of the water, the time and duration of water demand, and any other parameters that pertain to water use. The time and temperature monitor 100 then transmits the data to the microcontroller 140, which uses this data to learn the user's water usage patterns and to predict future water usage patterns based on historical data. For example, if the user takes a 20-minute hot shower at a temperature of 80° F. every morning at 7 am, the time and temperature monitor 100 can detect that pattern, send it to the microcontroller, and have the microcontroller 140 predict that 80° F. water will be needed for at least 20 minutes at 7 am the next day. The microcontroller 140 then transmits commands to the heater 160 and to the heat/energy storage and transfer device 150, activating them in advance of the 7 am time to allow sufficient time for the water to heat to the desired temperature, and making sure that enough hot water is stored to allow for a 20-minute shower.

The heater can be any water heater known in the art, as long as it is controllable by a microcontroller. The heat/energy storage and transfer device can be any device known in the art that can store sufficient heat energy to enable water to be heated to a temperature that is typically required in normal household hot water use. The heat/energy storage and transfer device can store heat energy (i.e. a heat coil) or can store actual hot water (for example, in a small hot water tank). It must also be controllable by a microcontroller.

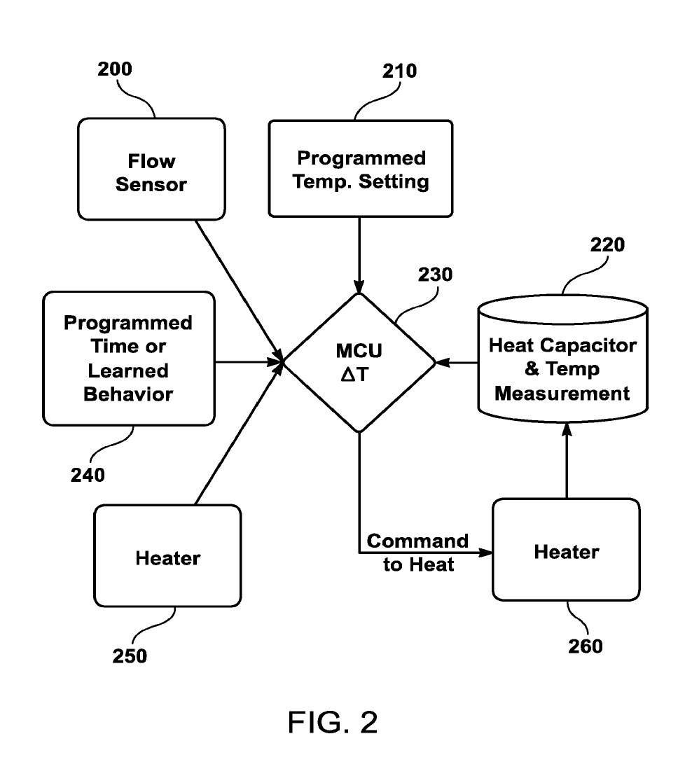

FIG. 2 shows a flowchart view of the preferred embodiment of the present invention. Data from a flow sensor 200, pre-programmed temperature settings 210, learned behavior 240, or user selections are input into the microcontroller 230 (labeled as MCU on the chart), which sends a command to the heater 260. The heat energy then goes to the heat capacitor 220. A temperature measurement device such as a thermocouple, a thermometer, or any other temperature measurement device known in the art, monitors the temperature of the heat capacitor 220, and sends data to the microcontroller 230; the microcontroller 230 then can use the temperature data to control the heater 260 and to shut it off when the desired temperature is reached.

It is to be noted that while the figures show learned behavior, preprogrammed temperature settings, and real-time user selections all used as input methods for the microcontroller, the invention can use only learned behavior and no user selections or pre-programmed settings, only user selections and no learned behavior or pre-programmed settings, only pre-programmed settings and no user selections or learned behavior, or any combination of those input methods. The invention can also use sensors to detect the presence of people in the house or in the near vicinity of the tap or shower, sensors to detect the opening or closing of a bathroom or kitchen door, a light sensor to detect when the light is turned on in the kitchen or bathroom, a sensor to detect when the user is in bed and therefore unlikely to use hot water, or any other sensors that can indicate the likelihood of a user desiring hot water at any given point in time. Those sensors may be used exclusively or in combination with any of the other input methods shown in FIG. 2.

The system may also comprise an off switch to enable the user to shut it off manually when not needed—for example, when the user is going out of town for prolonged periods of time and hot water is not required. This will result in further energy savings.

1. A heat storage device for water, comprising:
a controller, comprising a processor and memory;
a heat storage device controllable by the controller, said heat storage device capable of storing heat energy sufficient to heat a predetermined quantity of water;
a heater controllable by the controller, connected to the heat storage device;
a communications interface that enables the controller to communicate wirelessly with a mobile device.

2. The heat storage device of claim 1, where the mobile device is one of the following group: a smartphone, a tablet.

3. The heat storage device of claim 1, where the heat storage device is a heat capacitor.

4. The heat storage device of claim 1, where the heat storage device is a hot water tank.

5. The heat storage device of claim 1, further comprising a time and temperature monitor that analyzes water usage data, said time and temperature monitor connected to the controller.

6. The heat storage device of claim 5, where the water usage data comprises one or more of the following group: the amount of water demanded, the flow rate of the water, the quantity of water used, timing of water use, water pressure, water temperature, the duration of water demand.

7. The heat storage device of claim 5, where the controller uses the water usage data to predict the time, duration, and amount of future hot water demand, and activates the heater in time to provide a sufficient amount of hot water to meet the demand.

8. The heat storage device of claim 5, where the controller uses the water usage data to deactivate the heater when no hot water demand is anticipated.

9. The heat storage device of claim 1, where the app enables the user to input a hot water usage pattern into the controller, comprising one or more of the following parameters: timing, duration, and temperature.

10. The heat storage device of claim 1, where the app enables the user to activate or deactivate the heater.

11. The heat storage device of claim 1, further comprising:
a motion detector connected to the controller, said motion detector triggering the controller to turn on the heater when activated.

12. The heat storage device of claim 1, further comprising:
a light sensor connected to the controller, said light sensor triggering the controller to turn on the heater when activated.

13. The heat storage device of claim 1, further comprising:
a sensor to detect the opening of a door, said sensor triggering the controller to turn on the heater when activated.

14. The heat storage device of claim 1, further comprising:
a sensor to detect user behavior that is likely to lead to hot water demand, said sensor triggering the controller to turn on the heater when activated.

15. The heat storage device of claim 1, further comprising:
a sensor to detect user behavior that is likely to lead to no hot water demand, said sensor triggering the controller to turn off the heater when activated.

16. The heat storage device of claim 1, where the mobile device comprises a GPS module that communicates user location data to the controller and triggers it to turn on when a user is within a predetermined distance of the controller.
